(19) United States
(12) Patent Application Publication
(10) Pub. No.: US 2026/0326895 A1
(43) Pub. Date: Oct. 22, 2026

(54) DRIVE SYSTEM FOR A ROTARY-WING AIRCRAFT

(71) Applicant: KOPTER GERMANY GMBH, Höhenkirchen-Siegertsbrunn (DE)

(72) Inventors: Christopher Dennis HUPFER, Baiern (DE); Peter Maximilian Detmar EDELMANN, Weßling (DE)

(21) Appl. No.: 19/486,660

(22) PCT Filed: Apr. 11, 2024
(86) PCT No.: PCT/EP2024/059890

§ 371 Date: Nov. 21, 2025

(30) Foreign Application Priority Data
Jul. 20, 2023 (DE) 10 2023 206 915.6

(51) Int. Cl. B64C 27/12; B64C 27/00; B64C 27/06; B64D 27/33; B64D 27/357; B64D 31/04; B64D 31/09

(52) U.S. Cl. CPC B64C 27/12; B64C 27/006; B64C 27/06; B64D 27/33; B64D 27/357; B64D 31/04; B64D 31/09

(57) ABSTRACT

The invention relates to a drive system for a rotorcraft (10), comprising:
a main drive assembly (7) configured to generate power with which a main rotor (1) of the rotorcraft (10) can be driven,
a main transmission (6) configured to convert the power generated by the main drive assembly (7) into a torque acting on the main rotor (1),
an additional or emergency drive assembly (2) which is also configured to generate power for driving the main rotor (1), wherein the additional or emergency drive assembly (2) is arranged to be connectable to the main transmission (6) via a switchable coupling unit (3). The invention also relates to a rotorcraft (10) with such a drive system.

### TECHNICAL FIELD

The invention relates to a drive system for a rotorcraft, in particular a helicopter, and to such a rotorcraft.

### TECHNICAL BACKGROUND

Rotorcrafts, in particular helicopters, can be subject to increased requirements with regard to safety in the event of a drop in drive power or a complete failure of a main drive assembly. In the case of single-engine helicopters, safe emergency landings can be made in the known manner with the help of autorotation, provided the pilot has the necessary skills. However, its use in densely populated or otherwise critical areas is still very much restricted in practice by regulations (e.g., European aviation law on the operation of helicopters), because in such cases it is difficult to reach suitable landing sites.

Many helicopter types are therefore often equipped with two essentially identical and powerful main engines, which are operated outside their optimum operating point. In an emergency, the remaining engine then powers the helicopter on its own.

When weighing up economic efficiency and compliance with legal regulations and provisions, helicopter types that are equipped with, for example, only one main drive assembly and in addition with an auxiliary drive assembly for use in emergencies are also of interest. Thanks to improvements in storage options in recent years, auxiliary drive systems based on electric motors are also increasingly being considered.

US 2019/0352001 A1 describes a propulsion system for a helicopter with only one propulsion engine. An auxiliary propulsion device is provided for use in emergency situations, which is physically integrated into a turboshaft main engine and forms a single unit with it. The auxiliary propulsion engine is mechanically connected to a rear drive train that extends between a freewheel clutch (for power transmission from the main engine to the drive train) and the tail rotor transmission. Emergency propulsion via the entire drive train occurs when the rotation generated by the auxiliary propulsion engine is greater than that generated by the main propulsion engine (e.g., in the event of engine failure) or than that generated in the event of autorotation. The auxiliary propulsion engine may be based on an electric drive, among other things.

US 2022/0388673 A1 describes the coupling of an electric motor to the main rotor of a helicopter via a reduction gear consisting of gears of the main transmission.

US 2021/0229826 A1 describes a rotary wing aircraft provided with an engine and an assistance system having an electric motor that is used in emergencies. The electric motor is coupled to a secondary input of the main transmission via a connection module.

US 2020/0277072 A1 discloses a method for assisting a pilot of a single-engine rotary-wing aircraft during a flight phase in autorotation, wherein the rotary wing aircraft comprises a hybrid drive assembly with a main engine and an electric motor.

The operation of the main engine is monitored during flight to detect a drop in power at the main rotor, and then to control the electric machine so that it supplies additional power to the main rotor.

US 2020/0283139 A1 proposes a hybrid propulsion system in which, for example, a main drive assembly for driving the main rotor is provided by an internal combustion engine or an electric motor, while the tail rotor is driven by a separate motor that is operated hydraulically, electrically, or pneumatically.

The patent specification US 10,759,280 B2 proposes various coupling options for an electric motor in a hybrid drive system, for example, to the drive train coupled to the main engine, directly to the main transmission, or to the main rotor shaft extending from the main transmission.

Hybrid drive systems are also described in documents EP 4 015 377 A1 and WO 2021/151873 A1. EP 3 921 231 B1 proposes integrating an electric motor into at least one planet of a planetary gearset.

In most of the above-mentioned proposals, the electric auxiliary drives are connected directly to the main transmission or to the respective drive trains coupled to it. The main drive assembly is generally mechanically separated from the respective auxiliary drive by means of a mechanical freewheel clutch. However, the mechanical freewheel clutch requires lubrication, which increases maintenance requirement, and allows torque to be transmitted only in one direction. In addition, considering the large number of clamping elements in the freewheel clutch, it is to be observed that there are a large number of moving parts.

Furthermore, an auxiliary drive such as an electric motor is subject to the same high maintenance requirements as the other components of the drive system due to its direct connection to the main transmission or the drive train in order to ensure reliability, which increases the effort and costs of operation, even if the auxiliary drive is hardly ever used.

It is therefore an object to further improve the existing concepts of drive systems and to reduce the costs and effort involved in general operation.

### DESCRIPTION OF THE INVENTION

According to aspects of the invention that address one or more of the aforementioned needs, a drive system for a rotorcraft, in particular for a helicopter, comprises a main drive assembly which is configured to generate power with which a main rotor of the helicopter having several rotor blades can be driven, a main transmission, which is adapted to convert the power generated by the main drive assembly into a torque acting on the main rotor, and an additional or emergency drive assembly, which is also configured to generate power for driving the main rotor, wherein the additional or emergency drive assembly is arranged to be connectable to the main transmission via a switchable coupling unit.

The mechanical main transmission in a rotorcraft serves to transmit the drive torque of the engine to the main rotor and, if applicable, a coupled tail rotor at the correct rotational speed. The main transmission is designed to realize maximum torque. This can cause particular problems if, for example, the main drive assembly fails, and additional torque is required.

If, for example, residual power is still being transmitted from the main drive assembly while a corresponding auxiliary drive is already starting, this can lead to overload and permanent damage to the transmission. The same can also apply in the case of stabilized autorotation flight. In this case, power is transferred from the main rotor to the main transmission, but the auxiliary drive that is now being activated also feeds power into the main transmission, which can lead to overload.

This problem is solved by the switchable coupling unit provided by the invention. In contrast to a freewheel clutch, which only acts in one direction of rotation and as such cannot be controlled or switched, such a switchable coupling unit can be controlled and switched from outside in a targeted manner and depending on the situation. The switchable coupling unit allows the additional or emergency drive assembly provided in accordance with the aforementioned aspects to be connected to the main transmission in a controlled manner in such cases.

In particular, the activation of transmission of torque from the additional or emergency drive assembly can be controlled in a targeted manner. For example, the (not necessarily instantaneous) switching operation of the coupling unit can be performed depending on the current load on the main transmission. According to exemplary embodiments, a sensor and/or computing network may be available for this purpose, with which current rotational speeds in the main rotor, in the main transmission, and in drive trains are detected and the respective torques are calculated from this and compared with critical values. According to further exemplary embodiments, an additional or emergency drive control unit provided and described below can regulate the switching operation of the switchable coupling unit on this basis and, in coordination with the regulation, also control the power generation in the additional or emergency drive assembly.

A switchable clutch thus allows a seamless transition from a main drive via the main drive assembly to an auxiliary drive via the additional or emergency drive assembly without exceeding critical limit torques. According to the invention, this applies not only to emergencies in the event of failure or power loss of the main drive assembly, but also to merely supporting additional drive by the additional or emergency drive assembly, because in such cases the same problems of excessive torque at the moment of activating generally exist. The same applies in the case of power reversal, for example, if the additional or emergency drive assembly is an electric motor that is temporarily operated as an electric generator to charge a battery module.

In addition, the solution proposed here also allows controllable mechanical separation of the additional or emergency drive assembly from the main transmission and the main drive assembly during normal flight operation. This decouples the additional or emergency drive assembly from these components, and any malfunctions in this area do not directly rebound on the main transmission. This slightly reduces the maintenance interval requirements, which can reduce operating costs and effort.

The main drive assembly can be any type of prime mover, for example a thermodynamic machine, in particular a shaft turbine, e.g. having a gas generator and a power turbine, or a piston engine. However, other types, including electric motors, are also possible. If the rotorcraft is an autogyro, any type of traction or thrust engine can be provided. Aspects of the present invention generally also include the implementation of two main drive assemblies in the rotorcraft.

The main rotor of the rotorcraft may have any number of rotor blades. The implementation of double rotors may also be covered by aspects of the invention.

Optionally, a tail rotor transmission may also be coupled, but this is not mandatory for the implementation of the invention.

The switchable coupling unit comprises the actual clutch and control electronics. It replaces the freewheel clutch, which was previously the only coupling available for the additional or emergency drive assembly, with particular advantage, thereby eliminating the above-mentioned disadvantages of the latter. The switchable coupling unit is configured to connect or disconnect the additional or emergency drive assembly with/from the main transmission. The connection to the main transmission can be made directly (with an input of the main transmission) or indirectly via a drive train, which in turn is permanently coupled to the main transmission. A connection to the main transmission, for example via a coupling with the rotor mast, is not excluded.

The invention is not limited to specific types of switchable couplings. Examples include the multi-plate clutch, the pole friction clutch, the magnetic clutch, and the magnetic powder clutch. Of these, the pole friction clutch may be the most preferred because it is particularly suitable for the initially very high differential rotational speeds. The pole friction clutch operates in dry or wet running. In this type, the clutch is triggered by a current flow and a magnetic field that builds up, and the torque is transmitted by friction contact.

Alternatively, the aforementioned multi-plate clutch is also possible. It also operates in dry or wet running. Here, the release lever for generating the contact pressure is triggered electronically, while the power transmission is carried out via an electromagnet. The torque is transmitted purely mechanically by friction contact.

Furthermore, the magnetic clutch mentioned above can also be used. The torque is transmitted only via a magnetic field, making this type of clutch completely wear-free. In the case of the magnetic powder clutch, the torque is transmitted via stiffening magnetic powder particles. Triggering is achieved by an electric current, wherein a variable torque is particularly easy to achieve. However, further switchable or controllable coupling types that allow a controlled coupling process are also conceivable.

The terms switchable and controllable, as they relate to the coupling, are used synonymously in this application. This means that the clutch can be specifically actuated from the outside to establish or separate a connection between the additional or emergency drive assembly and the main transmission, and that the coupling operation itself can be controlled, i.e., the degree of torque transmission depending on the time (which in practice may be very short), e.g., due to friction, etc., depending on the type of coupling.

In a preferred embodiment, the additional or emergency drive assembly comprises an electric motor. This may further preferably be configured and dimensioned in such a way that a main rotor and/or tail rotor of a rotorcraft, in particular a helicopter, can be driven autonomously and without an additional drive. For the purposes of the present invention, an autonomous electric drive is understood to achieve a mechanical power of preferably at least 80 KW, preferably 100 kW to 700 KW, more preferably 300 kW to 400 kW, and most preferably around 600 kW. The electric motor may be a synchronous motor, but the invention is not limited to specific types of motors.

Electric motors have high torque, low wear, and very low latency until power is delivered, making control in coordination with the coupling process particularly advantageous.

In principle, several electric motors may also be provided.

According to a further development, a first battery module is provided which is arranged to supply the electric motor of the additional or emergency drive assembly with electrical energy. Battery types with high power density are preferred here.

According to special embodiments, the first battery module serves to supply the electric motor with energy in an emergency, e.g., in the event of engine failure or power loss. The storage capacity of the first battery module is sufficient for this purpose to achieve at least a flight range appropriate according to the circumstances in order to reach a suitable landing site and to allow a single safe landing, if necessary in conjunction with autorotation.

An embodiment that includes the above-mentioned types of couplings provides, accordingly, that the switchable coupling unit is electromechanically and/or electromagnetically switchable in order to selectively connect the additional or emergency drive assembly or the electric motor to the main transmission or to disconnect it therefrom.

According to a further development, the switchable coupling unit is arranged to couple and uncouple a drive shaft of the electric motor with an auxiliary drive train. This auxiliary drive train is connected to an input of the main transmission. The power generated by the main drive assembly can be supplied to the main transmission via a main drive train. A special feature here is that the main drive train is connected to the same input of the main transmission as the auxiliary drive train. This aspect has a particular advantage because the entire structure is particularly simple and space-saving. The additional or emergency drive assembly with the coupling can thus be easily arranged opposite the main drive assembly. The input of the main transmission can be formed, for example, by a sun gear that is in operative connection with a planetary gearset of the main transmission. It has been found that, in practice, unused installation space above the passenger cabin (upper area of the cabin body) in helicopters is available at the position described, for example, and this space can now be put to good use. The framing in this area often already has the necessary load-bearing capacity to support the electric motor.

A further aspect concerns an additional or emergency drive control unit mentioned above. It is configured to actuate the electric motor and to switch the switchable coupling unit depending on an activation criterion in order to connect the electric motor to the main transmission or to disconnect it from the latter.

According to a first embodiment of this aspect, the additional or emergency drive control unit is connected to a drive sensor system in order to detect a failure of the main drive assembly that has occurred or is imminent. It is configured to start the electric motor depending on the detection result as an activation criterion and to switch the coupling unit in order to connect the electric motor to the main transmission so that the main rotor is driven with the power by the electric motor in an emergency mode.

For this purpose, the drive sensor system can comprise one or more sensors for detecting at least one of the following values:
(a) rotational speed of the rotor,
(b) rotational speed of a gas generator of the main drive assembly,
(c) rotational speed of a power turbine of the main drive assembly, etc.

From these components, the additional or emergency drive control unit can not only detect the emergency situation, such as the power loss of the main drive, as described above, but can also calculate and track the current torque conditions during the subsequent switching or control of the switchable coupling unit. The coupling process can thus be dynamically adjusted depending on a currently detected and calculated torque in comparison with a specified critical torque.

However, this control is not only possible in the event of emergency mode, but also in a generator mode. For example, a second battery module may be provided which is arranged to supply the electric motor of the additional or emergency drive assembly with electrical energy, wherein the additional or emergency drive control unit is connected to a battery sensor system in order to detect a low battery charge state in the first and/or second battery module. Furthermore, it is configured to switch the coupling unit depending on the detection result as an activation criterion in order to connect the electric motor to the main transmission and operate it as a generator in a generator mode in order to charge the second battery module with a portion of the power of the main drive assembly converted into electrical power.

In contrast to the first battery module, which cannot be charged during flight operation, the second battery module can be rechargeable during flight operation. Thus, the first battery module in a secure environment is designed for emergency mode only and accordingly meets the higher safety requirements. The second battery module, on the other hand, can be used in particular to support ongoing flight operation (hereinafter referred to as auxiliary mode), but it does not have to meet the very high safety requirements and therefore requires less maintenance, as it is not critical for flight operations in this sense.

Accordingly, a further embodiment provides for connecting the additional or emergency drive control unit to a pilot control unit, wherein the pilot control unit comprises an input device and is configured to generate an input signal depending on an input by a pilot into the input device and to transmit it to the additional or emergency drive control unit. The additional or emergency drive control unit is further configured to start the electric motor depending on the transmitted input signal as an activation criterion and to switch the coupling unit to connect the electric motor to the main transmission so that the main rotor is driven in an auxiliary mode by power from the electric motor in addition to the power provided by the main drive assembly.

As described, the additional or emergency drive control unit may be configured to perform auxiliary mode using the electric motor based on an energy supply exclusively from the second battery module. The energy stored in the first battery module is reserved exclusively for emergencies, i.e., the first battery module does not need to be connected to any electrical consumers except for the electric motor and the additional or emergency drive control unit and corresponding battery sensors. The battery is only recharged or replaced during maintenance on the ground.

According to a further, non-limiting, specific exemplary embodiment of the invention already indicated above, the main drive assembly, the main transmission, and the additional or emergency drive assembly can be arranged substantially along a longitudinal axis of the rotorcraft, wherein the additional or emergency drive assembly and the main drive assembly are arranged on opposite sides of the main transmission. The additional or emergency drive assembly is preferably arranged in front of the main transmission in the intended direction of flight of the rotorcraft. This results in the advantages described. However, mounting the motor and coupling on the side of the main transmission is also not principally excluded.

The invention also relates to a rotorcraft, in particular a helicopter, which comprises a drive system according to one of the preceding aspects, embodiments, exemplary embodiments, or further developments. The additional or emergency drive assembly can be advantageously arranged in an installation space above a payload or passenger accommodation space provided in a cabin, in particular above a passenger compartment.

Furthermore, the invention also relates to the use of the drive system in a rotorcraft, in particular a helicopter.

Features, expediencies and advantages of the invention are also described below with reference to the figures and exemplary embodiments.

### BRIEF DESCRIPTION OF THE FIGURES

FIG. 1 shows a schematic representation of a rotorcraft or helicopter with a drive system according to an exemplary embodiment of the invention;

FIG. 2 shows a system drawing of the drive system according to FIG. 1;

FIG. 3 shows a schematic representation of a control network that accomplishes the additional or emergency drive, with the additional or emergency drive control unit shown in FIG. 2 as the central control device;

FIG. 4 shows a schematic representation of a control in emergency mode (Emergency Mode);

FIG. 5 as in FIG. 4, but for the auxiliary mode (Power Boost Mode);

FIG. 6 as in FIG. 4 or 5, but for the generator mode (Power Generator Mode):

FIG. 7 shows a side view of the drive system (without main drive assembly);

FIG. 8 shows a cross-section taken through the drive system (without main drive assembly).

### DETAILED DESCRIPTION OF PREFERRED EXEMPLARY EMBODIMENTS

In the following description of preferred exemplary embodiments, it should be noted that the present disclosure of the various aspects is not limited to the details of the structure and arrangement of the components as shown in the following description and in the figures. All exemplary embodiments, including those not shown in the figures, can be implemented or executed in various ways. It should further be noted that the language and terminology used herein are for the purpose of concrete description only and should not be interpreted by those skilled in the art as limiting.

Furthermore, in the following description, the same reference numerals in the figures denote the same or similar features or subject-matter, so that in some cases a repeated detailed description of the same is omitted in order to maintain the compactness and clearness of the presentation.

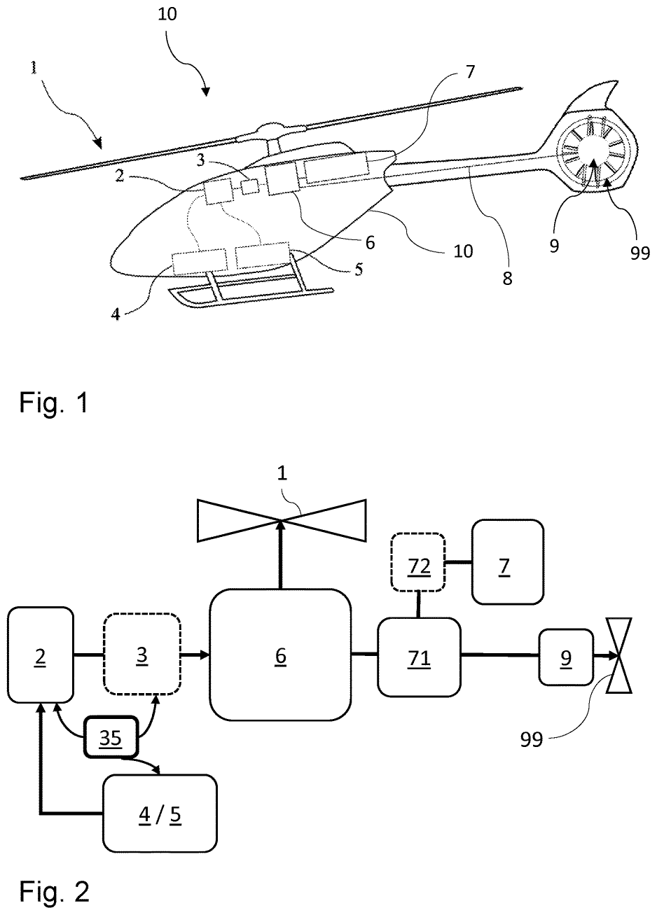

FIG. 1 shows a rotorcraft 10, in this case a helicopter, with a drive system according to an embodiment of the present invention. The rotorcraft 10 comprises a main rotor 1 equipped with, for example, two rotor blades, and a tail rotor 99. The main rotor 1 and the tail rotor 99 are driven by a main drive assembly 7. The main drive assembly 7 is, for example, a shaft power turbine with a gas generator and a power turbine. In order to convert a high rotational speed of the power turbine of, for example, 6800 rpm, into a high torque, a reducing main transmission 6 is provided. The main rotor 1 is ultimately operated at high torque at a reduced rotational speed, for example 350 rpm. The tail rotor 99 is rotated in a coordinated manner via a drive train 8, which connects the main transmission 6 to a tail rotor transmission 9.

The drive system of the helicopter shown in FIG. 1 also comprises an additional or emergency drive assembly 2, which is in particular an electric motor 21, for example a synchronous motor. The additional or emergency drive assembly 2 is connected to a first battery module 4 and a second battery module 5 each, so that these can selectively provide electrical energy for the operation of the additional or emergency drive assembly 2. The additional or emergency drive assembly 2 can be connected to or disconnected from the main transmission 6 via a switchable coupling unit 3 in order to implement different operating modes of the helicopter, which are described below with reference to FIGS. 4-6.

FIG. 2 shows a schematic view of the drive system from FIG. 1 in greater detail.

Power is transmitted from the main drive assembly 7 via a freewheel clutch 72, which disconnects the main drive assembly 7 from the drive train 8 when the corresponding rotational speed, reduced by the intermediate transmission 71, falls below that of the drive train 8. In normal operation, the drive torque is transmitted to the main transmission 6, in which the high torque for the main rotor 1 is generated.

On the other hand, FIG. 2 shows that the supply of electrical energy from the battery modules 4 and 5, the operation of the additional or emergency drive assembly 2 (i.e., the electric motor), and the switchable coupling unit 3 are controlled or regulated by an additional or emergency drive control unit 35.

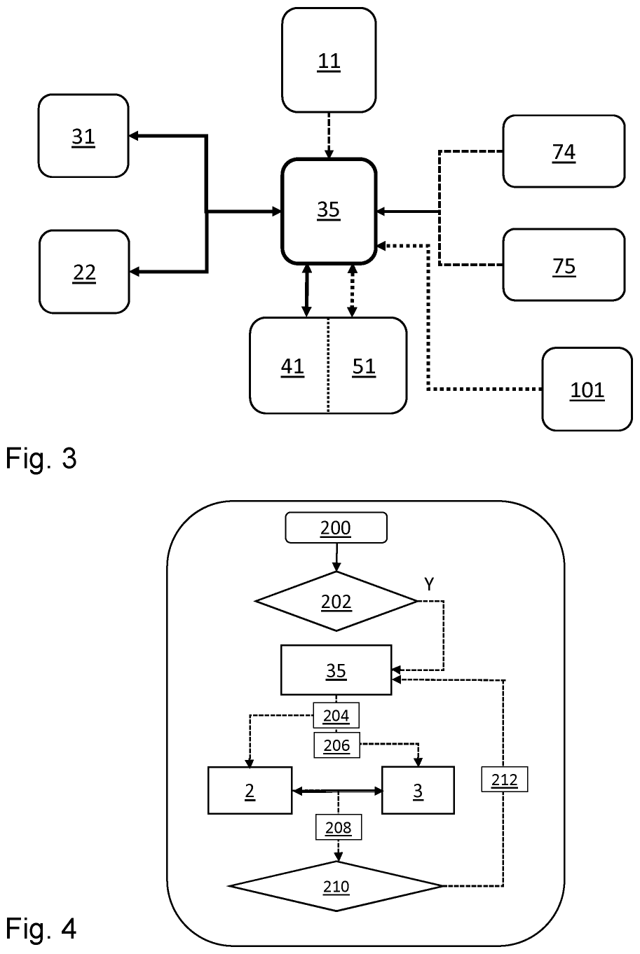

A network associated with the additional or emergency drive control unit 35 is shown in greater detail in FIG. 3. In this exemplary embodiment, the additional or emergency drive control unit 35 is connected to a comprehensive sensor system that allows the current state of the drive system to be evaluated. Dotted arrows indicate input from sensors 11, 74, and 75 of the drive system, which is active during normal operation. Specifically, these are a rotational speed sensor 11 for the main rotor, a rotational speed sensor 74 for the power turbine, and a rotational speed sensor 75 for the gas generator. The configuration of these sensors can be arbitrary. Such sensors are usually also present in conventional helicopters, so that the intervention in the existing system to implement the invention is minimal. Based on the rotational speeds detected and supplied by the sensors 11, 74, and 75, the additional or emergency drive control unit 35 can evaluate the presence of a critical state (activation criterion) by comparing them with specified critical values.

In addition, the additional or emergency drive control unit 35 can also use the transmitted rotational speeds to calculate the torque acting in the individual components and compare it with specified critical torque limits.

Furthermore, the additional or emergency drive control unit 35 is connected to a sensor/actuator 22 for the electric motor 21, which, for example, detects the rotational speed and/or phase position of the electric motor and transmits it to the additional or emergency drive control unit 35 or controls the motor power, and is connected to a sensor/actuator 31 for the coupling unit 3, which provides data on its switching state and position (bold arrows in FIG. 3) and switches the coupling unit 3. The transmitted data allows the additional or emergency drive control unit 35 to determine the torque currently transmitted from the electric motor 21 to the main transmission 6. Control via the actuators allows precise control of the motor start and coupling operation. In this way, the transition from main operation (only the main drive assembly supplies power) to emergency, auxiliary, or generator mode can be controlled appropriately.

The implementation of emergency mode 200 is schematically depicted in FIG. 4. In step 202, as described above, the additional or emergency drive control unit 35 determines whether a power drop has occurred (“Y”) and whether emergency mode should therefore be initiated (evaluation of the data from sensors 11, 74, or 75). In step 204, the additional or emergency drive control unit 35 first starts the electric motor 21 and then, in step 206, activates the coupling unit 3 to establish a connection between the electric motor 21 and the main transmission 6 (actuation of actuators 22 and 31). In step 208, the status with regard to the acting torques is checked (evaluation of the data from sensors 11, 22, 31, 74, and/or 75). In step 210, the calculated torques are compared with limit torques, and in step 212, feedback is provided to adjust the operation of the electric motor 21 and the coupling unit 3 in a control loop.

After safe landing, the connection between the electric motor 21 and the main transmission 6 can be disconnected again (opening the coupling) to allow the main rotor 1 to turn out.

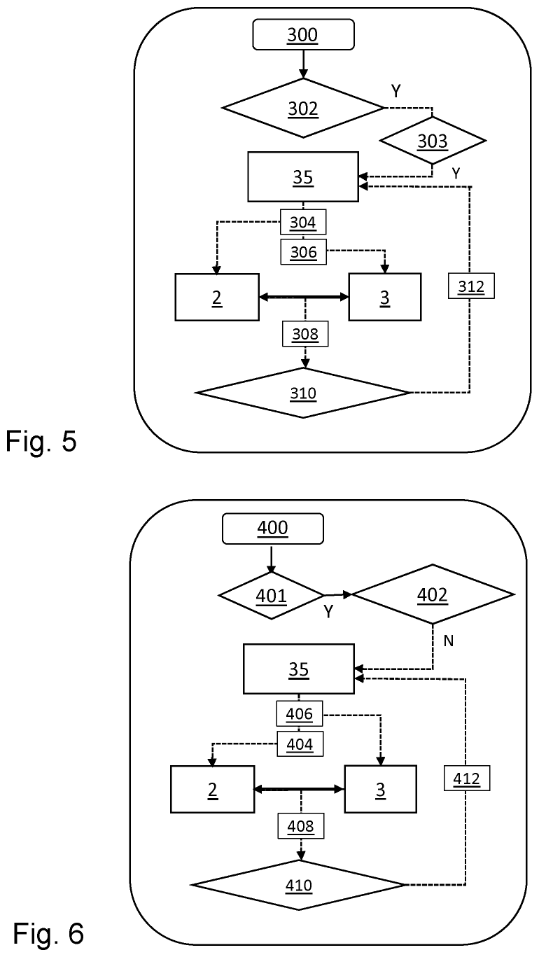

The above-mentioned auxiliary mode 300 is shown in FIG. 5. The basic procedure is very similar to that of the emergency mode, i.e., the coupling process is controlled in a control loop to monitor the torque. In step 302, the auxiliary mode 300 is activated via an input device of a pilot control device 101 shown in FIG. 3. More precisely, it is repeatedly checked whether the corresponding signal is present (“Y”). Before the auxiliary mode is actually performed, a check is made in step 303 to determine whether there is still sufficient stored energy in the second battery module 5 (see the battery sensor 51 connected to the additional or emergency drive control unit 35 in FIG. 3) to perform the auxiliary mode. If this is the case (“Y”), steps 304-312 control the electric motor 21 and the coupling unit 3 in a manner analogous to FIG. 4 in order to prevent damage from excessive torque.

The generator mode 400, also mentioned above, is shown in FIG. 6. The event that initiates generator mode 400 is when the charge state of the second battery module 5 falls below a specified value, wherein the values currently detected are regularly read out by the additional or emergency drive control unit 35 from the battery sensor 51 (see FIG. 3) and are compared with the specified limit value (step 401). In step 402, a check is made as to whether there is a power drop or failure of the main drive assembly. In this case, it must be ensured that the electric motor 21 of the additional or emergency drive assembly is quickly available for the transmission of drive torques. If this is not the case, in step 406 the coupling unit 3 is first actuated and then the electric motor 21 or the additional or emergency drive assembly 2 is switched to generator mode in order to charge the second battery module 5. The coupling process is checked for excessive torque in the control loop analogous to FIG. 4 or 5.

It should be noted that the additional or emergency drive control unit 35 can also check the battery charge state of the first battery module 4 by the corresponding battery sensor 41, as shown in FIG. 3.

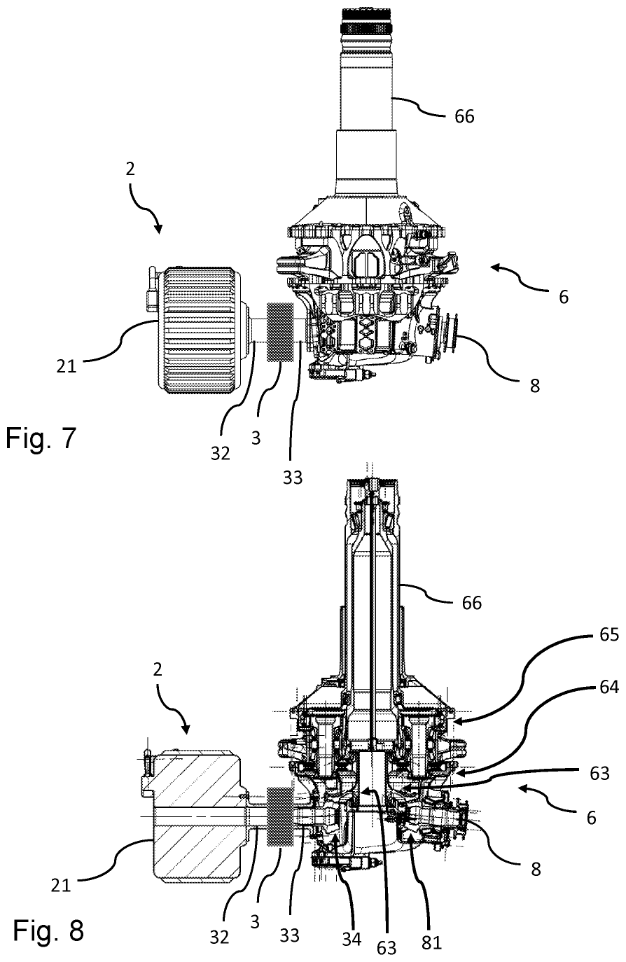

FIG. 7 shows a view of the main transmission 6 from the side with the rotor mast 66 and the additional or emergency drive assembly 2 connected to the main transmission 6. FIG. 8 shows the corresponding cross-section. The electric motor 21 has a motor shaft 32 which can be used with an auxiliary drive train 33 of the main transmission 6 via the switchable coupling unit 3. The cross-section in FIG. 8 shows that the auxiliary drive train 33 and the main drive train 8 engage with the same input in the main transmission 6, which is formed by the sun gear 63. For this purpose, the auxiliary drive train 33 has a gearing 34 and the main drive train 8 has a gearing 81. The sun gear 63 interacts in turn with a first stage 64 of a planetary gearing provided in the main transmission 6. A second stage 65 of the planetary gearing ultimately leads to a further reduction in the conversion and an increase in torque, which is ultimately transmitted to the rotor mast 66 via elements not shown in further detail but known to those skilled in the art. An exemplary structure of a main transmission 6 that can be implemented, which does not limit the present invention, is disclosed, for example, in EP 3 323 718 A1. Other concepts of main transmissions are also possible.

The above exemplary embodiments relate to a helicopter. However, the principles of the invention can also be applied analogously to other rotorcrafts such as gyrocopters or quadcopters, etc.

### LIST OF REFERENCE SIGNS

1 main rotor
11 rotational speed sensor for main rotor
2 additional or emergency drive assembly
21 electric motor
22 sensor/actuator for electric motor (rotational speed and/or phase position)
3 switchable coupling unit
31 sensor/actuator for coupling unit (switching state and position)
32 motor shaft (electric motor)
33 auxiliary drive train
34 gearing, bevel gear
35 additional or emergency drive control unit
4 first battery module, not rechargeable during flight operation
41 sensor for first battery module (charge state, temperature, voltage, etc.)
5 second battery module, rechargeable during flight operation
51 sensor for second battery module (charge state, temperature, voltage, etc.)
6 main transmission
63 input, sun gear
64 planetary gear, 1st stage
65 planetary gear, 2nd stage
66 rotor mast
7 main drive assembly
71 intermediate transmission
72 freewheel clutch
74 rotational speed sensor for power turbine
75 rotational speed sensor for gas generator
8 main drive train
81 gearing, bevel gear
9 tail rotor transmission
99 tail rotor
10 rotorcraft, helicopter
101 pilot control device, with input device
200 emergency mode (start)
300 auxiliary mode (start)
400 generator mode (start)

1. A drive system for a rotorcraft, comprising:
a main drive assembly configured to generate power with which a main rotor of the rotorcraft can be driven, the main rotor comprising a plurality of rotor blades,
a main transmission configured to convert the power generated by the main drive assembly into a torque acting on the main rotor,
an additional or emergency drive assembly which is also configured to generate power for driving the main rotor, wherein the additional or emergency drive assembly is arranged to be connectable to the main transmission via a switchable coupling unit.

2. Drive system according to claim 1, wherein
the additional or emergency drive assembly comprises an electric motor, and
wherein the main drive assembly preferably comprises a thermodynamic machine.

3. Drive system according to claim 2, further comprising:
a first battery module which is arranged to supply the electric motor of the additional or emergency drive assembly with electrical energy.

4. Drive system according to claim 3, wherein
the switchable coupling unit is electromechanically and/or electromagnetically switchable in order to selectively connect the additional or emergency drive assembly or the electric motor to the main transmission or disconnect it therefrom.

5. Drive system according to claim 3, wherein
the switchable coupling unit is arranged to couple and uncouple a drive shaft of the electric motor to and from an auxiliary drive train,
the auxiliary drive train is connected to an input of the main transmission,
the power generated by the main drive assembly is supplied to the main transmission via a main drive train, and
the main drive train is connected to the same input of the main transmission as the auxiliary drive train.

6. Drive system according to claim 5, wherein
the input of the main transmission is formed by a sun gear that is in operative connection with a planetary gearset

7. Drive system according to claim 3, further comprising:
an additional or emergency drive control unit which is configured to actuate the electric motor and to switch the switchable coupling unit depending on an activation criterion in order to connect the electric motor to the main transmission or to disconnect it from the latter.

8. Drive system according to claim 7, wherein
the additional or emergency drive control unit is connected to a drive sensor system in order to detect a failure of the main drive assembly that has occurred or is imminent, and is configured to start the electric motor depending on the detection result as an activation criterion and to switch the coupling unit in order to connect the electric motor to the main transmission so that the main rotor is driven in an emergency mode by the power of the electric motor.

9. Drive system according to claim 8, wherein the drive sensor system comprises one or more sensors for detecting at least one of the following:
(a) rotational speed of the rotor,
(b) rotational speed of the gas generator,
(c) rotational speed of the power turbine,

10. Drive system according to claim 7. further comprising
a second battery module which is arranged to supply the electric motor of the additional or emergency drive assembly with electrical energy,
wherein the additional or emergency drive control unit is connected to a battery sensor system to detect a low battery charge state in the first and/or second battery module and is arranged to switch the coupling unit, depending on the detection result as an activation criterion, to connect the electric motor to the main transmission and operate it in a generator mode as a generator in order to charge the second battery module with a portion of the power of the main drive assembly converted into electrical power.

11. Drive system according to claim 10, wherein
the first battery module is not designed to be rechargeable during flight operation; and
the second battery module is designed to be rechargeable during flight operation.

12. Drive system according to claim 7, wherein
the additional or emergency drive control unit is connected to a pilot control unit, wherein the pilot control unit comprises an input device and is configured to generate an input signal depending on an input by a pilot into the input device and transmit it to the additional or emergency drive control unit,
wherein the additional or emergency drive control unit is arranged to start the electric motor depending on the transmitted input signal as an activation criterion and to switch the coupling unit to connect the electric motor to the main transmission so that the main rotor is driven in an auxiliary mode by power from the electric motor in addition to the power from the main drive assembly.

13. Drive system according to claim 12, further comprising a second battery module which is arranged to supply the electric motor of the additional or emergency drive assembly with electrical energy, wherein
the additional or emergency drive control unit is arranged to perform the auxiliary mode by means of the electric motor based on an energy supply exclusively from the second battery module.

14. Drive system according to er claim 1, wherein
the first battery module is not connected to any electrical consumer except for the electric motor and the additional or emergency drive control unit and corresponding battery sensors.

15. Drive system according to claim 1, wherein
the main drive assembly, the main transmission and the additional or emergency drive assembly are arranged substantially along a longitudinal axis of the rotorcraft, wherein the additional or emergency drive assembly and the main drive assembly are arranged on opposite sides with respect to the main transmission,
wherein the additional or emergency drive assembly is preferably arranged in front of the main transmission in the intended direction of flight of the rotorcraft.

16. Rotorcraft, in particular a helicopter, comprising a drive system according to claim 1, wherein
the additional or emergency drive assembly is arranged in an installation space above a payload accommodation space provided in a cabin, in particular above a passenger compartment.

17. Use of a drive system according to claim 1 in a rotorcraft, in particular a helicopter.
